(19) United States
(12) Patent Application Publication
(10) Pub. No.: US 2013/0146737 A1
(43) Pub. Date: Jun. 13, 2013

(54) SUPPORT MECHANISM WITH MULTIPLE RODS

(71) Applicant: QING-SONG WEN, Shenzhen City (CN)

(72) Inventor: QING-SONG WEN, Shenzhen City (CN)

(73) Assignee: HON HAI PRECISION INDUSTRY CO., LTD., Tu-Cheng (TW)

(21) Appl. No.: 13/597,615

(22) Filed: Aug. 29, 2012

(30) Foreign Application Priority Data
Dec. 11, 2011 (CN) 201110413517.X

(51) Int. Cl. F16M 11/24

(52) U.S. Cl. 248/421

(57) ABSTRACT

A support mechanism includes a base, two guide poles positioned on the base, two guide poles positioned on the base, a support block slidably sleeved on the two guide poles, a V-shaped rod rotatably connected to a side of the base, a support rod rotatably connecting the V-shaped rod to the support block, and a L-shaped hook rotatably positioned on the V-shaped rod. The L-shaped hook comprises a support pole for supporting the support block.

### BACKGROUND

1. Technical Field

The present disclosure generally relates to support mechanisms, and particularly, to a support mechanism with multiple rods.

2. Description of the Related Art

A support mechanism is used to position an object at different heights. The support mechanism generally has a cylinder. The cylinder includes a main body and a piston rod movably connected to the main body, and the object is positioned on the piston rod. However, a manufacturing cost of the support mechanism is relatively high due to a high cost of the cylinder.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric, assembled view of an embodiment of a support mechanism including a support block and a base.

FIG. 2 is a side view of the support mechanism of FIG. 1 with the support block at a maximum height relative to the base.

FIG. 3 is a side view of the support mechanism of FIG. 1 with the height of the support block decreasing.

FIG. 4 is a side view of the support mechanism of FIG. 1 with the support block at a minimum height relative to the base.

### DETAILED DESCRIPTION

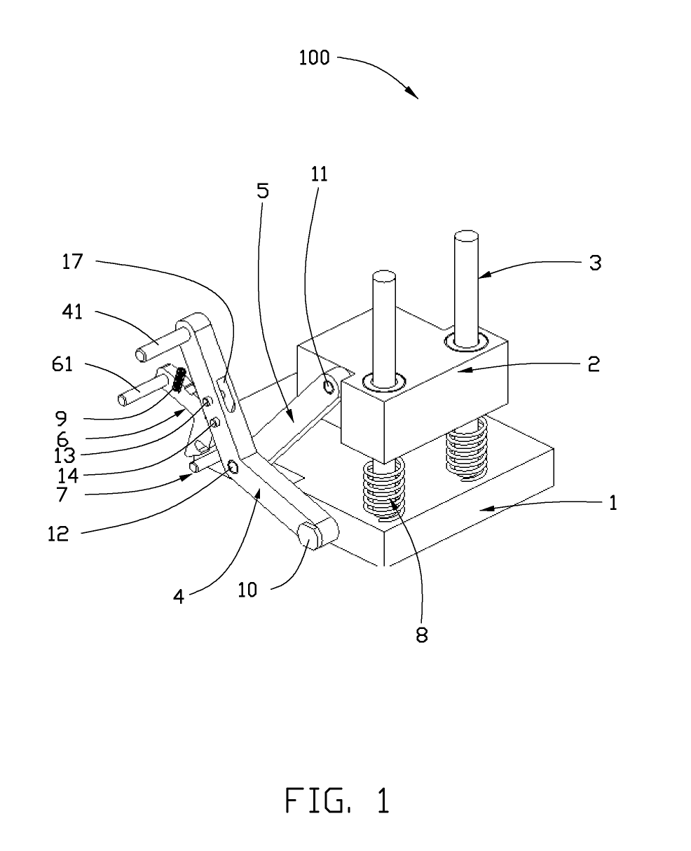

Referring to FIG. 1, an embodiment of a support mechanism 100 includes a base 1, a support block 2, two guide poles 3, a V-shaped rod 4, a support rod 5, a L-shaped hook 6, a pin 7, two first elastic members 8, a second elastic member 9, a first shaft 10, a second shaft 11, a third shaft 12, a fourth shaft 13, and a positioning pole 14. In the illustrated embodiment, the first elastic members 8 and the second elastic member 9 are compression springs.

The guide poles 3 are parallelly positioned on the base 1, and the first elastic members 8 are sleeved on the guide poles 3. The support block 2 is sleeved on the guide poles 3, and thus the first elastic members 8 are positioned between the base 1 and the support block 2. One end of the V-shaped rod 4 is rotatably connected to a side of the base 1 via the first shaft 10, and the other end of the V-shaped rod 4 forms an operating portion 41. The V-shaped rod 4 further defines a cutout 17 adjacent to the operating portion 41. One end of the support rod 5 is rotatably connected to a side of the support block 2 via the second shaft 11, and the other end of the support rod 5 is rotatably connected to a middle portion of the V-shaped rod 4 via the third shaft 12. The L-shaped hook 6 is positioned on the V-shaped rod 4 via the fourth shaft 13, and the L-shaped hook 6 is adjacent to the operating portion 41. The positioning pole 14 is positioned on the V-shaped rod 4 and adjacent to the fourth shaft 13. The L-shaped hook 6 comprises a support pole 61 formed on a first end, and defines an engaging groove 15 in a second end. The second elastic member 9 is positioned on the L-shaped hook 6 and adjacent to the support pole 61. The pin 7 is positioned on a side of the base 1. In an alternative embodiment, the support mechanism 100 may includes two or more guide poles 3 and two or more first elastic members 8.

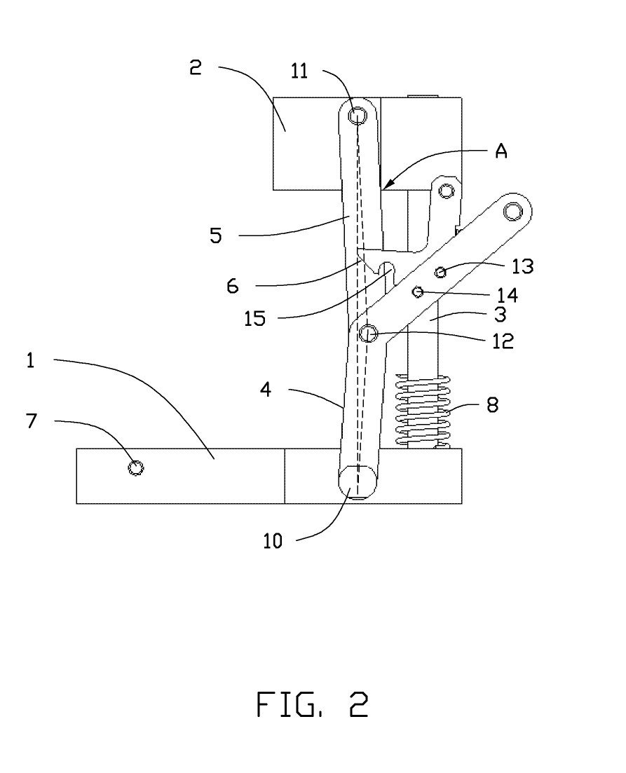

Referring to FIGS. 1 through 4, in use, the V-shaped rod 4 is rotated in a clockwise direction about the first shaft 10 by applying an external force on the operating portion 41, and simultaneously, the support rod 5 is rotated about the third shaft 12. Therefore, the support block 2 is driven to slide along the guide poles 3. When the support pole 61 is resisted with the support block 2, and the positioning pole 14 supports the L-shaped hook 6, the external force is withdrawn. The support block 2 is then positioned at a maximum height relative to the base 1, and an angle a formed by the first shaft 10, the second shaft 11, a third shaft 12 is approximately 180 degrees (see FIG. 2).

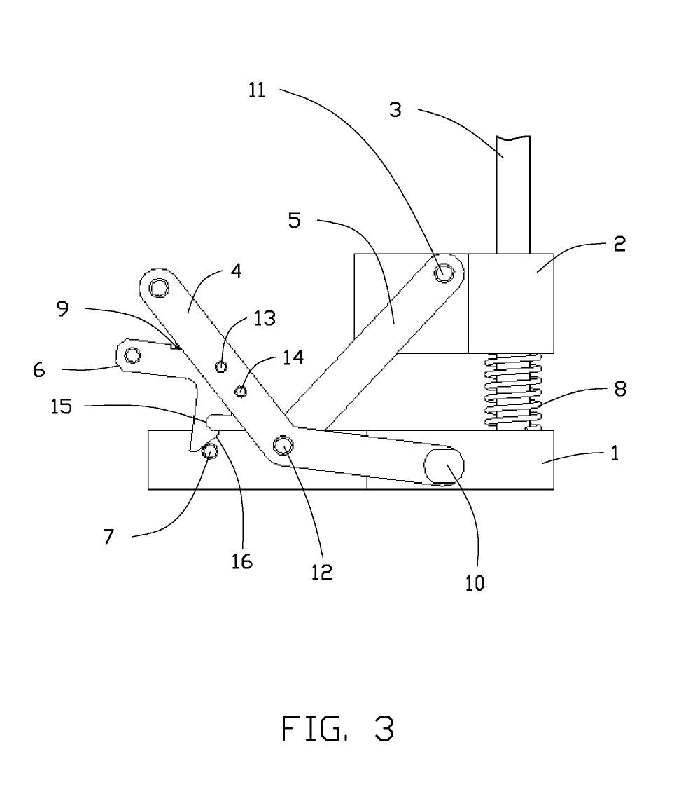

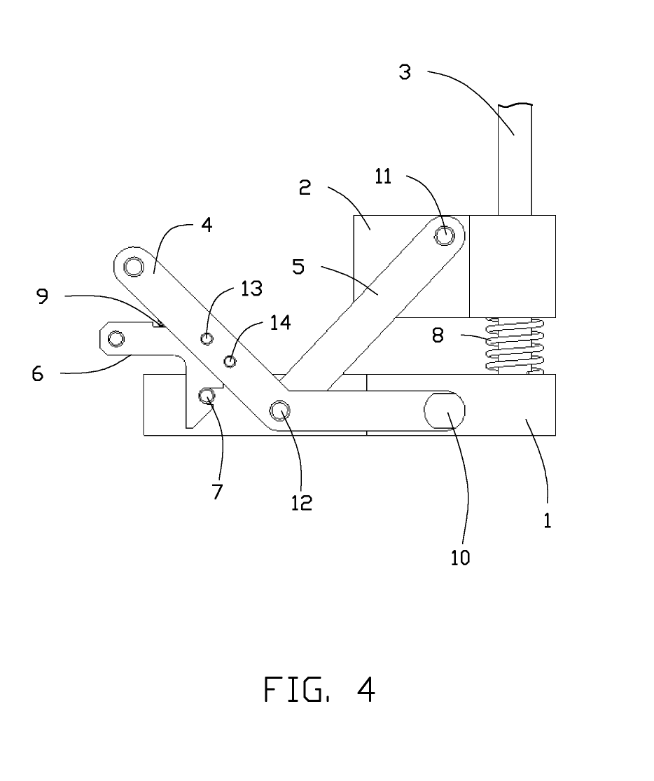

If the height of the support block 2 needs to be reduced, the external force is applied on the operating portion 41 to cause the V-shaped rod 4 to rotate in a counter-clockwise direction about the first shaft 10, and the support rod 5 rotate about the third shaft 12 simultaneously. A height of the support block 2 is reduced, and then the first elastic member 8 is compressed by the support block 2 (see FIG. 3). When the V-shaped rod 4 is further rotated, the pin 7 engages into the engaging groove 15 of the L-shaped hook 6, and the second elastic member 9 is compressed between the L-shaped hook 6 and the V-shaped rod 4 (see FIG. 4). Thus, the support block 2 is at a minimum height relative to the base 1.

A height of the support block 2 relative to the base 1 can be adjusted by rotating the V-shaped rod 4, and the support block 2 can be firmly supported at a minimum height and a maximum height. Therefore, the support mechanism 100 is easily operated and has a relatively low manufacturing cost.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A support mechanism, comprising:
a base;
at least two guide poles positioned on the base;
a support block slidably sleeved on the at least two guide poles;
a V-shaped rod rotatably connected to a side of the base;
a support rod rotatably connecting the V-shaped rod to the support block; and
a L-shaped hook rotatably positioned on the V-shaped rod, wherein the L-shaped hook comprises a support pole for supporting the support block.

2. The support mechanism of claim 1, further comprising a first shaft, wherein the V-shaped rod is rotatably connected to the base via the first shaft.

3. The support mechanism of claim 2, further comprising a second shaft and a third shaft, wherein one end of the support rod is rotatably connected to a side of the support block via the second shaft, and the other end of the support rod is rotatably connected to a middle portion of the V-shaped rod via the third shaft.

4. The support mechanism of claim 3, further comprising a fourth shaft, wherein the L-shaped hook is rotatably positioned on the V-shaped rod via the fourth shaft.

5. The support mechanism of claim 4, further comprising a positioning pole positioned on the V-shaped rod and adjacent to the fourth shaft.

6. The support mechanism of claim 1, further comprising at least two first elastic members sleeved on the at least two guide poles and between the base and the support block.

7. The support mechanism of claim 6, further comprising a second elastic member positioned on the L-shaped hook and adjacent to the support pole.

8. The support mechanism of claim 1, further comprising a pin, wherein the L-shaped hook defines an engaging groove, and the pin is positioned on a side of the base and engaged in the engaging groove.

9. A support mechanism, comprising:
a base;
at least two guide poles positioned on the base;
a support block slidably sleeved on the at least two guide poles;
a pin positioned on a side of the base;
a V-shaped rod rotatably connected to a side of the base;
a support rod rotatably connecting the V-shaped rod to the support block; and
a L-shaped hook rotatably positioned on the V-shaped rod, wherein the L-shaped hook defines an engaging groove for receiving the pin.

10. The support mechanism of claim 9, further comprising a first shaft, wherein the V-shaped rod is rotatably connected to the base via the first shaft.

11. The support mechanism of claim 10, further comprising a second shaft and a third shaft, wherein one end of the support rod is rotatably connected to a side of the support block via the second shaft, and the other end of the support rod is rotatably connected to a middle portion of the V-shaped rod via the third shaft.

12. The support mechanism of claim 11, further comprising a fourth shaft, wherein the L-shaped hook is rotatably positioned on the V-shaped rod via the fourth shaft.

13. The support mechanism of claim 12, further comprising a positioning pole positioned on the V-shaped rod and adjacent to the fourth shaft.

14. The support mechanism of claim 9, further comprising at least two first elastic members sleeved on the at least two guide poles and between the base and the support block.

15. The support mechanism of claim 14, further comprising a second elastic member positioned on the L-shaped hook and adjacent to the support pole.
